(19) United States
(12) Patent Application Publication
(10) Pub. No.: US 2025/0294297 A1
(43) Pub. Date: Sep. 18, 2025

(54) METHOD FOR OPERATING A HEARING AID SYSTEM AND A HEARING AID SYSTEM

(71) Applicant: Sivantos Pte. Ltd., Singapore (SG)

(72) Inventors: Peter NIKLES, Erlangen (DE); Hamed HASANI, Erlangen (DE); Andreas PFROMMER, Erlangen (DE)

(21) Appl. No.: 19/078,547

(22) Filed: Mar. 13, 2025

(30) Foreign Application Priority Data
Mar. 13, 2024 (DE) 10 2024 202 373.6

(51) Int. Cl. H04R 25/00; G06F 3/01

(52) U.S. Cl. CPC H04R 25/305; G06F 3/011; H04R 25/554; H04R 25/609

(57) ABSTRACT

A method operates a hearing aid system which has a hearing aid with a sensor and a first radio communication unit, and a further device. A manual actuation is detected by the sensor, and a prompt to emit a test signal is sent to the further device by the hearing aid. The test signal is sent to the hearing aid by use of the further device and is received thereby by the first radio communication unit. The manual actuation is verified on the basis of physical properties of the received test signal.

### CROSS-REFERENCE TO RELATED APPLICATION

This application claims the priority, under 35 U.S.C. § 119, of German Patent Application DE 10 2024 202 373.6, filed Mar. 13, 2024; the prior application is herewith incorporated by reference in its entirety.

### FIELD AND BACKGROUND OF THE INVENTION

The invention relates to a method for operating a hearing aid system and a hearing aid system. The hearing aid system contains a hearing aid having a sensor and a first radio communication unit.

People who suffer from a loss of hearing typically use a hearing aid device, which is a hearing aid. In this case, ambient sound is usually converted into an electrical (audio/sound) signal by means of a microphone, thus an electromechanical sound transducer, so that the electrical signal is captured. The captured electrical signals are processed by means of an amplifier circuit and introduced by means of a further electromechanical transducer in the form of a receiver into the auditory canal of the person. Moreover, the captured sound signals are usually processed, for which a signal processor of the amplifier circuit is typically used. The amplification is adapted in this case to a possible hearing loss of the hearing aid wearer.

Depending on the current situation, it is possible in this case that a different amplification is desired by the person, thus the user. It is also possible that a specific functionality of the hearing aid is temporarily desired by the user, such as the use of a directional characteristic, so that ambient sound from a specific direction is preferably amplified. Alternatively or in combination therewith, such a functionality is noise suppression, by means of which, for example, wind noises or the like are reproduced to a reduced extent. To start the functionality, a corresponding input by the user is required, which usually takes place by means of a manual actuation. For this purpose, the hearing aid has a mechanical switch, however. Liquids or the like can penetrate into the hearing aid in the area of the switch, for example. One alternative therefore provides using a capacitive sensor. By means of this it is possible to detect an approach of a finger of the user to the hearing aid and to trigger the specific functionality depending thereon.

For esthetic reasons, the hearing aid usually has a comparatively small construction. It is then possible, however, that the touch surface of the hearing aid assigned to the capacitive sensor is at least partially covered or overlapped by other parts of the body, such as parts of the pinna. If the sensitivity of the sensor is set comparatively high, it is possible that even minor changes of the location of the hearing aid with respect to the ear or minor movements of the ear, which are each induced, for example, due to physical activity, result in inadvertent triggering of the functionality. In contrast, if the sensitivity is set comparatively low, it is possible that an actual touch by the user will not be detected, so that the functionality is not carried out.

### SUMMARY OF THE INVENTION

The invention is based on the object of specifying a particularly suitable method for operating a hearing aid system and a particularly suitable hearing aid system, wherein in particular operation is improved for a user.

This object is achieved, according to the invention, with respect to the method by the features of the independent method claim and with respect to the hearing aid system by the features of the independent hearing aid system claim. Advantageous refinements and embodiments are the subject matter of the respective dependent claims.

With the foregoing and other objects in view there is provided, in accordance with the invention, a method for operating a hearing aid system having a hearing aid with a sensor and a radio communication unit, and a further device. The method includes detecting a manual actuation by means of the sensor; sending a prompt to emit a test signal, from the hearing aid to the further device; sending the test signal to the hearing aid by means of the further device and the test signal is received thereby by means of the radio communication unit; and verifying the manual actuation on a basis of physical properties of the test signal received.

The method is used for operating a hearing aid system. The hearing aid system has a hearing aid. For example, the hearing aid is a headphone or contains a headphone. Alternatively, the hearing aid is a headset, true wireless headphone, hearable, or personal sound amplifier. The hearing aid is particularly preferably a hearing aid device, however. The hearing aid device is used to assist a person suffering from a loss of hearing. In other words, the hearing aid device is a medical device by means of which, for example, a partial hearing loss can be compensated for. The hearing aid device is, for example, a “receiver-in-the-canal” hearing aid device (RIC; ex-receiver hearing aid device), an “in-the-ear” hearing aid device, an “in-the-canal” hearing aid device (ITC), or a “complete-in-canal” hearing aid device (CIC), hearing aid glasses, a pocket hearing aid device, a bone vibrator hearing aid device, or an implant. In a further alternative, the hearing aid device is a “behind-the-ear” hearing aid device, which is worn behind a pinna.

The hearing aid is intended and configured to be worn on the human body. In other words, the hearing aid preferably contains a holding device, by means of which fastening on the human body is possible. If the hearing aid is a hearing aid device, the hearing aid is intended and configured to be arranged, for example, behind the ear or inside an auditory canal. In particular, the hearing aid is wireless and is intended and configured to be at least partially inserted into an auditory canal. The hearing aid particularly preferably contains an energy storage device, by means of which an energy supply is provided.

The hearing aid preferably has a microphone, which is used for capturing sound. In particular, ambient sound, or at least a part thereof, is captured by means of the microphone in operation. The microphone is in particular an electromechanical sound transducer. The microphone has, for example, only a single microphone unit or multiple microphone units, which interact with one another. Each of the microphone units expediently has a membrane, which is set into vibrations due to soundwaves, wherein the vibrations are converted into an electrical signal by means of a corresponding pickup device, such as a magnet which is moved in a coil. It is therefore possible to capture an audio signal, which is based on the sound incident on the microphone unit, by means of the respective microphone unit. The microphone units are configured in particular as unidirectional. The microphone is expediently arranged at least partially inside a housing of the hearing aid and is therefore at least partially protected.

The hearing aid expediently has a receiver for outputting an output signal. The output signal is in particular an electrical signal in this case. The receiver is an electromechanical sound transducer, preferably a loudspeaker. Depending on the design of the hearing aid, in the intended state the receiver is at least partially arranged inside an auditory canal of a wearer of the hearing aid, thus a person, or at least acoustically connected thereto. The wearer is also referred to hereinafter as a user or hearing aid wearer. The hearing aid is used in particular primarily to output the output signal by means of the receiver, wherein corresponding sound is created. In other words, the main function of the hearing aid is outputting the output signal. The output signal is in particular at least partially created here depending on the sound captured by means of the microphone. Alternatively, the output signal is created depending on a transmitted data signal (audio signal) or the data signal is used for this purpose. In other words, the output signal is in particular created on the basis of a streaming process or it is a playback of a specific sample in this case.

The hearing aid expediently contains a signal processor, which suitably forms a signal processing unit or is at least a component part thereof. However, the hearing aid at least expediently contains a corresponding signal processing unit. The signal processor is, for example, a digital signal processor (DSP) or is implemented by means of analog components. In particular the (audio) signal created/transmitted by means of the possible microphone is adapted by means of the signal processor, preferably depending on a possible hearing loss of a wearer of the hearing aid. An A/D converter is expediently arranged between the microphone and the signal processing unit, for example, the signal processor, if the signal processor is designed as a digital signal processor. The signal processor is in particular set depending on a parameter set. An amplification is specified in different frequency ranges by means of the parameter set, so that the audio signal created/transmitted by means of the microphone is processed in accordance with specific specifications, in particular depending on a hearing loss of the wearer of the hearing aid. The hearing aid particularly preferably additionally comprises an amplifier, or the amplifier is at least partially formed by means of the signal processor. For example, the amplifier is connected upstream or downstream from the signal processor with respect to signaling.

The hearing aid furthermore has a first radio communication unit, which is expediently connected to the possible signal processing unit and/or the possible receiver. The first radio communication unit is used here in particular to receive the audio signal/data signal to be transmitted and/or control parameters/settings for the possible signal processing unit or another control unit of the hearing aid. Alternatively or in combination therewith, the radio communication unit is in particular used to transmit data from the hearing aid to a further device of the hearing aid system.

The hearing aid furthermore has a sensor. The sensor is used for manual actuation, so that it is possible to detect a manual actuation by means of the sensor. The sensor is suitable, in particular intended and configured, for this purpose. To detect the manual actuation, corresponding measurement data/signals are suitably generated by means of the sensor, which are evaluated, for example, by means of the possible signal processing unit or other component parts of the hearing aid/sensor.

The other device is, for example, a portable device and is, for example, a smart phone or wearable. Alternatively thereto, the further device is a further hearing aid, which is, for example, structurally identical or at least similar to the hearing aid. In particular, the hearing aids are only modified with respect to the external dimensions and one of them is assigned to the left ear and the other to the right ear of the user. In other words, the two hearing aids are constructed in mirror image. Alternatively thereto, for example, the further hearing aid does not have a sensor. If the further device is a hearing aid, the hearing aid system is in particular designed as binaural. It is at least possible to communicate with the further device by means of the first radio communication unit of the hearing aid and therefore to exchange data/signals between the hearing aid and the further device, namely by means of radio.

In the method, a manual actuation is detected by means of the sensor. For this purpose, corresponding measurement data are suitably generated by means of the sensor, which in particular indicate the manual actuation. In other words, corresponding signals/measurement data are therefore detected or generated, which are also detected upon a manual actuation. However, it is possible that such signals/measurement data are also induced due to a malfunction or other circumstances. In other words, it is not ensured after the detection of the manual actuation that an actual manual actuation was also carried out by the user. In summary, it is possible that the manual actuation is detected although it has not actually taken place.

After the detection, a prompt to emit a test signal is sent by the hearing aid to the further device. This prompt is received by means of the further device. For example, the test signal is always identical or is adapted to the requirement. Alternatively or in combination therewith, an adaptation to a current situation of the hearing aid system and/or the hearing aid takes place, which is ascertained by means of the further device and/or by means of the hearing aid and is transmitted in the prompt.

By means of the further device, the test signal is then sent to the hearing aid and is received thereby by means of the first radio communication unit. In other words, the test signal is therefore transmitted by means of radio from the further device to the hearing aid. The emission of the test signal takes place after reception of the prompt, for example, in a specific time interval, or particularly preferably immediately, so that the time span is reduced until the test signal is received by the hearing aid.

The manual actuation is verified on the basis of physical properties of the received test signal. The physical properties of the received test signal are expediently ascertained for this purpose, in particular by means of the hearing aid. For this purpose, in particular the test signal is analyzed, for example, its reception strength, frequency, length, and/or other properties. In particular, the content of the test signal itself is not taken into consideration for the verification and this is formed, for example, solely by means of a periodic oscillation. In summary, the content of the test signal itself is not taken into consideration for the verification of the manual actuation, and the content of the test signal itself, for example, is always identical or is independent of a current situation of the hearing aid.

If the manual actuation actually takes place, a hand or other extremity of the user is (briefly) additionally located in the area of the sensor and therefore also in the area of the first radio communication unit. As a result, the test signal which is sent to the hearing aid is at least partially corrupted/changed by means of the hand/extremity or at least modified, which is reflected in the physical properties. The verification of the manual actuation then takes place on the basis thereof. If the change is not present, the hand is therefore also not located in the area of the first radio communication unit. In this case, the manual actuation is not verified. In summary, the manual actuation is therefore in particular verified if a change of the test signal is present.

In particular, a corresponding function/functionality of the hearing aid system is only carried out when the manual actuation has been verified. In other words, the verified manual actuation is used as a (user) input. Only actual manual actuations are verified and therefore used as an input due to the method, wherein it is not necessary to reduce a sensitivity of the sensor, so that, for example, a manual actuation which is actually carried out is not detected. Rather, it is possible to increase the sensitivity of the sensor so that, for example, manual actuation is also incorrectly detected by means of this sensor. The incorrectly detected manual actuations are sorted out here by means of the following verification, and only actual manual actuations are verified. Therefore, a function/functionality is not incorrectly triggered in the method and all actual manual actuations of the user are detected as a verified manual actuation by the hearing aid system. The hearing aid system therefore behaves in accordance with the inputs of the user and a level of comfort is increased for this user. It is also not necessary in this case to transmit the test signal substantially continuously from the further device to the hearing aid, but rather this only takes place after the corresponding notification of the actual manual actuation is present, thus the manual actuation was detected. A power consumption is therefore reduced. A radiation load of the user is also reduced.

The method is therefore used in particular for the verified detection of the manual actuation of the hearing aid system, in particular the hearing aid. A touch or at least an approach is used, for example, as a manual actuation, so that the manual actuation is in particular a contactless actuation. For example, the manual actuation corresponds to a gesture and therefore has a chronological course/change. For example, the touch is a single or multiple tap or a continuous touch lasting for a specific time span is used.

In particular, a specific function/functionality of the hearing aid is carried out depending on the verified detected manual actuation, thus the input. In particular, a selection of other control parameters takes place here, and/or the first radio communication unit is used for receiving and/or sending other (useful) data/(useful) signals. For example, a selection of signals which are fed to the signal processor and/or the receiver takes place depending on the input, so that the hearing aid is switched, for example, between the reproduction of ambient sound or the output of signals received by means of the first radio communication unit.

For example, this prompt is transmitted in a wired manner to the further device. However, this particularly preferably takes place wirelessly, in particular by means of radio. The first radio communication unit is also used, for example, to transmit the prompt from the hearing aid to the further device. Alternatively thereto, another radio communication unit is used, in particular a second (radio) communication unit.

For example, the prompt meets a specific standard, for example, a WLAN standard, a Bluetooth standard, or a UWB standard. The prompt is particularly preferably transmitted to the further device by means of magnetic induction. In particular the second radio communication unit is used for this purpose. In particular, NFMI (“near field magnetic induction”) is used for this purpose. Such a transmission is comparatively robust and is only comparatively slightly influenced due to the possible presence of the hand of the user. It is therefore ensured that the prompt is received by means of the further device, and that the test signal is emitted. If the test signal is thus only received weakly or is not received by means of the first radio communication unit, this is in particular because of influencing factors interfering with the mode of operation of the first radio communication unit, such as the hand, but not because the prompt was not received by the further device and was therefore not emitted. Moreover, only a small amount of data is necessary for sending the prompt, so that any restrictions do not have an effect during the transmission by means of magnetic induction. It is also ensured in this way that the prompt is actually received by the further device.

For example, the test signal is transmitted by means of magnetic induction to the hearing aid. However, the test signal is particularly preferably transmitted by means of Bluetooth to the hearing aid. The first radio communication unit therefore meets the Bluetooth standard. As a result, it is possible to use already existing components for the first radio communication unit, so that production costs are reduced. It is also possible due to the Bluetooth standard to also use the first radio communication unit for further functions of the hearing aid system, for example, for receiving the possible data signal/audio signal and/or control parameters. Required hardware is therefore reduced. It is also possible, for example, to use a further device, which is already present and is intended to transmit Bluetooth signals. The test signal in particular has a carrier frequency between 2.4 GHz and 2.5 GHz due to the Bluetooth standard. As a result, the test signal is influenced/changed comparatively strongly upon the presence of the hand or another extremity in the area of the first radio communication unit, which is reflected in the physical properties of the received test signal. An erroneous verification is therefore substantially precluded.

Suitably, the further device likewise has a first radio communication unit or at least a radio communication unit meeting the Bluetooth standard. For example, the radio communication unit of the further device is operated unchanged when sending the test signal. However, the test signal is particularly preferably sent at an increased signal strength. Since the test signal is comparatively short, the power consumption is only slightly increased. However, in this way a change of the physical properties is detectable comparatively accurately.

For example, the test signal is only transmitted on a single channel to the hearing aid. A power consumption is therefore reduced. The same channel, in particular the same frequency, is always used for this purpose, for example. The reception of the test signal is therefore facilitated, and it is not necessary to monitor multiple channels for this purpose, which increases a level of robustness and reduces a power consumption. Alternatively thereto, the channel in which the test signal is transmitted is defined depending on specific conditions and/or adapted to the current situation. In particular, a channel in which otherwise comparatively little activity prevails is used for this purpose, so that the test signal is not interfered with by other influences. Alternatively thereto, the test signal is transmitted on multiple channels to the hearing aid. Preferably, the test signal is also received on multiple channels by the hearing aid here. In other words, the test signal contains multiple portions which in particular always have the same content but are assigned to different channels. A comparatively accurate ascertainment of the physical properties is therefore enabled, and if a change is present, it can be checked whether it is only present in a single channel, which is an indication of an interference source, for example, but not the presence of the hand. However, if the change is broadband and relates to all channels/portions, for example, the hand is located in the surroundings, so that the verification of the manual actuation is simplified. Due to the multichannel nature of the test signal, it is ensured that in the event of interference in one of the channels, a portion of the test signal is nonetheless received by the hearing aid. For example, the physical properties of only a portion of the test signal are evaluated by means of the hearing aid. An effort is therefore reduced. However, all received parts of the test signal are preferably evaluated, so that an accuracy in the ascertainment of the physical properties is improved.

For example, a resonance shift is used as a physical property. If the hand of the user is located in the area of the sensor and therefore also in the area of the first radio communication unit, the resonance frequency of the first radio communication unit will be shifted. The frequency of the test signal, in contrast, is in particular identical and the signal strength of the received test signal is less the further away it is from the resonance frequency. As a result, it is possible to draw inferences on the basis of the signal strength about the resonance shift and therefore as to whether the hand is located in the area of the first radio communication unit. If no resonance shift is present or this is less than an assigned limiting value, the hand is not present in this case. A comparatively robust verification is therefore enabled, wherein extensive calculations are not required for this purpose. Alternatively thereto, the first radio communication unit is designed such that it is always operated in the range of its resonance, thus in particular also upon reception of the test signal. It is therefore already known due to the operation of the first radio communication unit by which amount a resonance shift is present, so that no additional evaluation is necessary. An effort is therefore further reduced.

Alternatively or in combination therewith, the RSSI (“Received Signal Strength Indication”) or the signal-to-noise ratio (SNR) of the test signal is used as a physical property. In other words, the RSSI of the test signal is ascertained. For verification, it is compared to a comparison value. If the test signal has a comparatively low RSSI/strength and/or low signal-to-noise ratio, the manual actuation is verified. If the RSSI is less than the comparison value, the manual actuation is verified in particular. This is because if the hand is present, excess damping of the test signal takes place, so that the RSSI is comparatively low. If the RSSI is less than the comparison value, the manual actuation is verified. The RSSI is already created/ascertained in this case, for example, in the scope of the radio communication by means of the first radio communication unit, thus in normal operation, and parameters of the first radio communication unit are adapted on the basis thereof, for example. Essentially no additional effort is therefore provided, and a special adaptation is not necessary. For example, the comparison value is constant or time-dependent. In this case, in particular a gesture is verified as the manual actuation.

The comparison value is, for example, specific for the hearing aid and is ascertained, for example, by a producer of the hearing aid and stored therein. This is carried out, for example, individually for each hearing aid or for the respective type of the hearing aid, thus the hearing aid type. Alternatively thereto, the comparison value is adapted to the respective user. In this case, for example, upon initial startup or in the context of setting the hearing aid, the comparison value is ascertained once or multiple times. In this case, in particular a routine is carried out in which the test signal is transmitted to the hearing aid by the further device, wherein the user is prompted to move his hand away from the hearing aid. In contrast, during a following transmission of the test signal, the user is prompted to keep his hand in the area of the hearing aid or to move it in accordance with a gesture. On the basis of the change between the two received test signals, the comparison value is ascertained and stored in the hearing aid. The prompts to the user are output, for example, by means of the possible receiver. Alternatively thereto, a so-called app is used for this purpose, which is executed on a smart phone or a wearable. For example, this represents the further device, or the smart phone/wearable is provided in addition to the further device. On the basis of the adaptation to the user, his physiological properties are taken into consideration, so that an incorrect verification of a falsely detected manual actuation does not take place. A level of comfort is therefore further increased.

In one alternative, the mean value of the RSSI of further signals received by means of the first radio communication unit is used as the comparison value. In other words, the further signals are received by means of the further radio communication unit, which signals in particular have a specific content, on the basis of which a setting or another influence of the hearing aid takes place. Expediently, the first radio communication unit meets the Bluetooth standard in this case, and the further signals in particular contain data which are used for the operation of the hearing aid. In other words, in this case these are useful signals. The RSSI is created for each of these further signals, for example, solely on the basis of the method or already in the context of the normal operation of the first radio communication unit. The mean value of this RSSI is formed, for example, the arithmetic, sliding, or exponential mean value. This mean value then represents the comparison value, or the mean value is additionally multiplied by a factor. A comparatively accurate adaptation to the respective current situation takes place due to the use of the mean value, so that the manual actuation can also verify reliably and in an error-free manner even in comparatively unfavorable situations/surroundings.

The hearing aid system contains a further device and a hearing aid. The hearing aid preferably has a microphone, an output device, and a signal processing unit. A signal path is formed in particular by means of these, and the microphone is preferably used to capture sound and the output device is suitably used to output sound. For example, the hearing aid is a headphone or contains a headphone. In this case, the hearing aid is designed, for example, as a so-called headset. However, the hearing aid is particularly preferably a hearing aid device. The hearing aid device is used to assist a person suffering from a loss of hearing. In other words, the hearing aid device is a medical device by means of which, for example, a partial hearing loss is compensated for. The hearing aid device is, for example, a “receiver-in-the-canal” hearing aid device (RIC; ex-receiver hearing aid device), an “in-the-ear” hearing aid device, an “in-the-canal” hearing aid device (ITC), or a “complete-in-canal” hearing aid device (CIC), hearing aid glasses, a pocket hearing aid device, a bone vibrator hearing aid device, or an implant. Particularly preferably, the hearing aid device is a “behind the ear” hearing aid device, which is worn behind a pinna.

The hearing aid has a first radio communication unit and a sensor. The further device expediently likewise contains a first radio communication unit. The two first radio communication units expediently meet the same standard in this case. It is possible in this case to connect the hearing aid and the further device for signaling by means of a radio connection, for which the two first radio communication units are used.

The hearing aid system is operated according to a method in which a manual actuation is detected by means of the sensor. A prompt to emit a test signal is sent to the further device by the hearing aid, for which a second radio communication unit of the hearing aid and/or the further device is expediently used. The test signal is sent to the hearing aid by means of the further device, in particular by means of the possible first radio communication unit of the further device, and received by the hearing aid by means of the first radio communication unit. The manual actuation is verified on the basis of physical properties of the received test signal. If a verification occurs, this is used as an input of the user, otherwise the hearing aid system is in particular operated as if the manual actuation had not been detected.

The hearing aid expediently contains a signal processor, which suitably forms the signal processing unit or is at least a component part thereof. The signal processor is, for example, a digital signal processor (DSP) or is implemented by means of analog components. By means of the signal processing unit the verification is expediently carried out and/or in particular the physical properties are ascertained.

For example, the sensor is formed by means of the possible microphone or another microphone. In this case, the manual actuation is detected in particular due to the noise arising when the hand strikes/meets a housing of the hearing aid. Alternatively or in combination therewith, the detection takes place on the basis of wind noises induced by the movement of the hand. It is possible in each case here that corresponding noises are also generated in another manner, wherein the incorrectly detected manual actuations are sorted out on the basis of the verification.

In an alternative, the sensor is an acceleration sensor. If the housing of the hearing aid is touched by means of the hand, it is moved briefly and the acceleration taking place as a result thereof is detected by means of the sensor. It is possible here that the hearing aid is moved accordingly due to a head movement of the user, for example, in the context of a physical activity. This erroneously detected manual actuation is also sorted out on the basis of the verification.

The sensor is particularly preferably a capacitive sensor. In particular a chronologically variable electromagnetic field is created by means of this sensor during operation and a current flow resulting between two electrodes of the capacitive sensor is ascertained. The current flow is dependent here on the amount/arrangement of electrically conductive materials in the surroundings. Therefore, for example, the manual actuation could be detected incorrectly due to existing moisture and/or a deformation of the ear. However, in these cases the test signal will not be excessively corrupted, so that the incorrectly detected manual actuations are also sorted out by means of the verification. Such a sensor is also comparatively cost-effective, has a small structure, and operation is comparatively thrifty.

For example, the further device is a smart phone/wearable, on which in particular a corresponding app is executed, by means of which the sending of the test signal to the hearing aid is effectuated. The smart phone/wearable can also be used for other purposes in this case or the user already has it. Production costs for the hearing aid system are therefore reduced. Alternatively thereto, the further device is a further hearing aid. This is different from the hearing aid, for example. However, the two hearing aids are particularly preferably structurally identical to one another and differ in particular solely on the basis of the geometric design, wherein one of the two hearing aids is suitable, in particular is intended and configured, for the left ear and the other for the right ear of a wearer. The hearing aid system is therefore in particular designed as binaural. Due to such a design, it is possible to detect and verify a corresponding manual actuation at each of the two hearing aids, so that a corresponding input is recognized. This only applies, for example, in each case to the hearing aid at which the manual actuation took place. The hearing aids can therefore be operated differently. It is also possible to use identical parts, because of which production costs are reduced.

The invention furthermore relates to a hearing aid which is suitable, in particular is intended and configured, to form a component part of such a hearing aid system.

The refinements and advantages described in conjunction with the method are also to be transferred accordingly to the hearing aid system/the hearing aid and vice versa.

Other features which are considered as characteristic for the invention are set forth in the appended claims.

Although the invention is illustrated and described herein as embodied in a method for operating a hearing aid system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is an illustration showing a user who wears a hearing aid system;

FIG. 2 is a flow chart showing a method for operating the hearing aid system; and

FIG. 3 is a graph showing a time curve of the RSSI of a signal received by means of a first radio communication unit of the hearing aid.

### DETAILED DESCRIPTION OF THE INVENTION

Parts corresponding to one another are provided with the same reference signs in all figures.

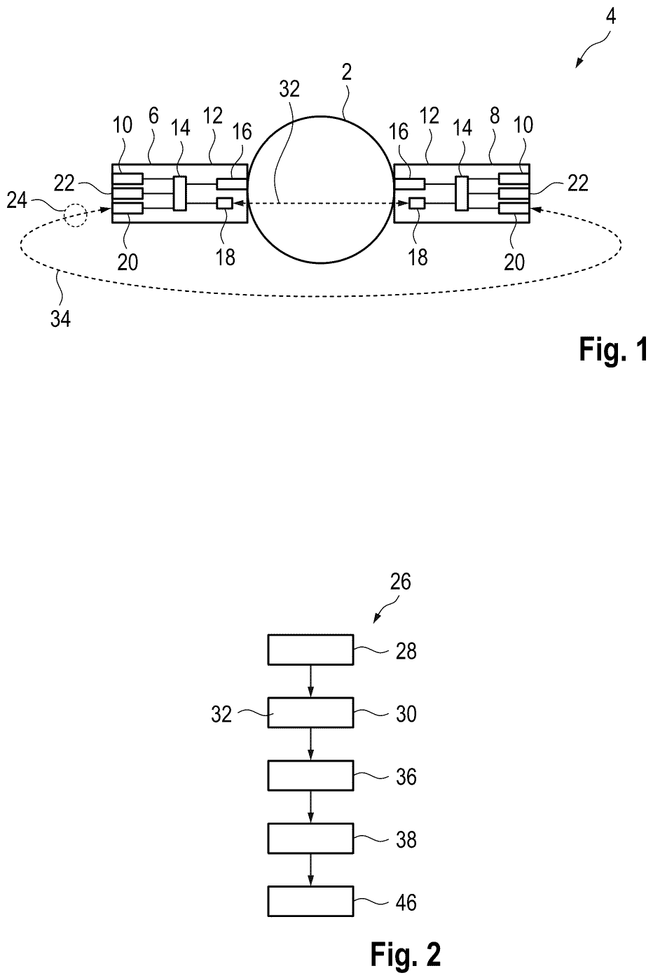

Referring now to the figures of the drawings in detail and first, particularly to FIG. 1 thereof, there is shown schematically a top view of a user 2 of a hearing aid system 4. The user 2 wears the hearing aid system 4, which is configured as a hearing aid device system. In other words, a partial hearing loss of the user 2 is compensated for by means of the hearing aid system 4. The hearing aid system 4 has a hearing aid 6 and a further hearing aid 8, which are each hearing aid devices. The hearing aid 6 and the further hearing aid 8 are mirror images of one another and are therefore structurally identical. In other words, the two hearing aids 6, 8 differ solely due to the geometry, and one of the hearing aids 6, 8 is assigned to the left ear and the other to the right ear of the user 2.

Each hearing aid 6, 8 has a microphone 10, by means of which ambient sound is captured during operation. The microphone 10 is arranged inside a respective housing 12 and is connected for signaling to a signal processing unit 14. By means of this unit, the signals created by means of the respective microphone 10 on the basis of the ambient sound are processed and conducted to a receiver 16. The processed signals are in turn output by means of the receiver 16 as sound in an auditory canal of the user 2. Comprehensibility is improved for the user due to the processing of the signals, which is adapted to the hearing loss of the user 2, using the signal processing unit 14. The housings 12 are configured here such that they are located inside the auditory canal, so that the hearing aids 6, 8 are only visible in a comparatively minor way.

Each hearing aid 6, 8 furthermore has a second radio communication unit 18, by means of which a signal exchange between the two hearing aids 6, 8 is enabled. The magnetic field is used for this purpose, and the second radio communication unit therefore uses magnetic induction (NFMI; “near field magnetic induction”), to transmit data between the two hearing aids 6, 8. Processing of the provided by means of the respective microphone 10 also takes place on the basis of the transmitted data, so that a three-dimensional impression is improved for the user 2.

Each hearing aid 6, 8 also has a first radio communication unit 20, which is also connected to the signal processing unit 14. The first radio communication unit 20 meets the Bluetooth standard, and a signaling connection to a smart phone, for example, is enabled by means of this unit. A signaling connection of the two hearing aids 6, 8 to one another is also enabled by means of the first radio communication unit 20, wherein the transmittable amount of data is increased in comparison to the second radio communication unit 18.

Each hearing aid 6, 8 also has a sensor 22, which is assigned to the end of the housing 12 facing away from the user 23 and is designed as a capacitive sensor. By means of this, the approach of a hand 24 or a finger of the user 2 to the respective housing 12 is detected, so that, for example, a setting of the signal processing unit 14 is changed. In summary, the hearing aid system 4 therefore contains the hearing aid 6, which contains the first radio communication unit 20 and the sensor 22, which is designed as a capacitive sensor. Furthermore, the hearing aid system 4 contains the further hearing aid 8, which forms a further device of the hearing aid system 4 and is constructed in a mirror image to the hearing aid 6.

FIG. 2 shows a method 26 for operating the hearing aid system 4, which is at least partially carried out by means of the two signal processing units 14. The hearing aid system 4 is operated according to the method 26 and a further method (not shown in more detail), in which the roles of the hearing aid 6 and the further hearing aid 8 are exchanged.

In the method 26, a manual actuation is detected in a first work step 28 by means of the sensor 22. This is detected when the hand 24 has approached the sensor 22 by more than a specific distance, which is ascertained on the basis of corresponding measurement data of the sensor 22. In other words, when a measurement signal provided by means of the sensor 22, namely a specific electric current, is greater than a threshold value, the manual actuation is detected. However, such measurement data can also result if the housing 12 moves in the assigned ear, for example, during physical activity of the user 2.

In a subsequent second work step 30, a prompt 32 to emit a test signal 34 is sent from the hearing aid 6 to the further hearing aid 8, and therefore to the further device, by the hearing aid 6 by means of the second radio communication unit 18. Since the second radio communication unit 18 is used, the prompt 32 is transmitted by means of magnetic induction to the further device. The further device is requested/prompted to emit the test signal 34 by means of the prompt 32.

In a subsequent third work step 36, the test signal 34 is sent from the further device, thus the further hearing aid 8, to the hearing aid 6 and is then received thereby. The respective first radio communication unit 20 is used for the emission/reception, so that the test signal 34 is transmitted by means of Bluetooth to the hearing aid 6. During the emission, the transmission power of the first radio communication unit 20 is increased in comparison to normal operation, and the test signal 34 is emitted on multiple channels by the further hearing aid 8 and therefore transmitted on multiple channels to the hearing aid 6. If the hand 24 is located in the area of the sensor 20, the test signal 34 is at least partially damped by the hand 24, and the resonance frequency of the first radio communication unit 20 of the hearing aid 6 is changed.

In a subsequent fourth work step 38, the physical properties of the received test signal 34 are ascertained, wherein this is carried out for all channels of the test signal 34. For this purpose, it is ascertained which resonance frequency the first radio communication unit 20 had upon reception of the test signal 34. This is compared with a resonance frequency which the first communication unit 20 has when no hand 24 is present, and which is stored in a memory (not shown in more detail) of the signal processing unit 14. In other words, the resonance (frequency) shift is ascertained. If the hand 24 is therefore present, the resonance frequency is shifted.

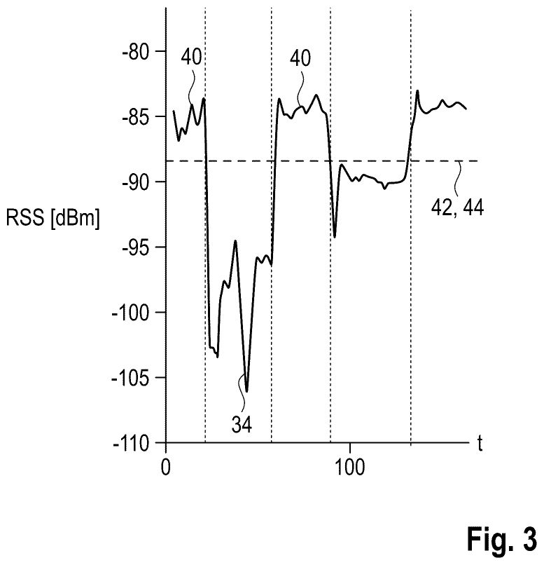

Alternatively or in combination therewith, the RSSI (“received signal strength indication”) of the test signal 34 is ascertained. The RSSI of the test signal 34 and of further signals 40 is shown in FIG. 3, wherein the further signals 40 are received from a smart phone (not shown in more detail) by means of the first radio communication unit 20 during operation of the hearing aid 6, and contain control parameters. During normal operation, the hand 24 is not located in the area of the hearing aid 6, because of which the RSSI is then increased. When the hand 24 is located in the area of the sensor 20 and therefore also in the area of the first radio communication unit 20, the RSSI is reduced and is at least less than a mean value 42 of the RSSI of the remaining further signals 40 received by means of the first radio communication unit 20.

The mean value 42 therefore represents a comparison value 44, and it is checked whether the RSSI of the test signal 34 is less than the comparison value 44, or whether the resonance frequency has shifted by more than a specific value. In summary, the physical properties of the received test signal 34 are therefore ascertained in the fourth work step 38, namely either the resonance frequency or the RSSI. If the resonance has shifted by more than a specific value, the manual actuation is verified. The manual actuation is also verified if the RSSI of the test signal 34 is less than the comparison value 44, wherein the mean value 42 of the RSSI of the further signals 40 received by means of the first radio communication unit 20 is used as the comparison value 44.

When the verification has occurred, this is used as an input and a fifth work step 46 is carried out. In this step, a specific function of the hearing aid 6 is carried out and, for example, a parameter set of the signal processing unit 14 is changed. The function carried out corresponds in this case to the type of the manual actuation, as if the hand 24 has been moved for a comparatively long time, a short time, or multiple times toward the sensor 22.

The invention is not restricted to the above-described exemplary embodiment. Rather, other variants of the invention can be derived therefrom by a person skilled in the art without departing from the subject matter of the invention. In particular, all individual features described in conjunction with the exemplary embodiment can furthermore also be combined with one another in another manner without departing from the subject matter of the invention.

The following is a summary list of reference numerals, and the corresponding structure used in the above description of the invention:
2 user
4 hearing aid system
6 hearing aid
8 further hearing aid
10 microphone
12 housing
14 signal processing unit
16 receiver
18 second radio communication unit
20 first radio communication unit
22 sensor
24 hand
26 method
28 first work step
30 second work step
32 prompt
34 test signal
36 third work step
38 fourth work step
40 further signal
42 mean value
44 comparison value
46 fifth work step

1. A method for operating a hearing aid system having a hearing aid with a sensor and a radio communication unit, and a further device, which comprises the steps of:
detecting a manual actuation by means of the sensor;
sending a prompt to emit a test signal, from the hearing aid to the further device;
sending the test signal to the hearing aid by means of the further device and the test signal is received thereby by means of the radio communication unit; and
verifying the manual actuation on a basis of physical properties of the test signal received.

2. The method according to claim 1, which further comprises transmitting the prompt by means of magnetic induction to the further device.

3. The method according to claim 1, which further comprises transmitting the test signal by means of Bluetooth to the hearing aid.

4. The method according to claim 1, which further comprises transmitting the test signal on multiple channels to the hearing aid.

5. The method according to claim 1, which further comprises using a resonance shift as one of the physical properties.

6. The method according to claim 1, which further comprises using a received signal strength indication (RSSI) of the test signal as one of the physical properties and the received signal strength indication of the test signal is compared with a comparison value for a verification.

7. The method according to claim 6, which further comprises using a mean value of the RSSI of further signals received by means of the radio communication unit as the comparison value.

8. A hearing aid system, comprising:
a hearing aid having a sensor a communication unit;
a further device; and
the hearing aid system being operated according to the method according to claim 1.

9. The hearing aid system according to claim 8, wherein said sensor is a capacitive sensor.

10. The hearing aid system according to claim 8, wherein said further device is a further hearing aid.
